(19) United States
(12) Patent Application Publication
(10) Pub. No.: US 2022/0365534 A1
(43) Pub. Date: Nov. 17, 2022

(54) SYSTEMS AND METHODS FOR MISSION PLANNING

(71) Applicant: GE Aviation Systems LLC, Grand Rapids, MI (US)

(72) Inventors: Michael Joseph Kuhlman, Malden, MA (US); Anup Menon, Palo Alto, CA (US)

(21) Appl. No.: 17/742,904

(22) Filed: May 12, 2022

Related U.S. Application Data
(60) Provisional application No. 63/188,276, filed on May 13, 2021.

(51) Int. Cl. G05D 1/00

(52) U.S. Cl. CPC G05D 1/0094; G05D 1/0022; G05D 1/0027

(57) ABSTRACT

Systems and methods for flight mission planning are provided. One embodiment of a method includes defining a mission to be performed by a plurality of assets, where defining the mission includes defining an area for the mission and a target for the mission, determining, available assets for completing the mission, and determining a capability for the available assets. Some embodiments include defining operations to complete the mission, based on the capability of the available assets and assigning each of the operations to respective assets of the available assets to complete the mission, where assigning each of the operations incudes communicating customized instructions to each of the respective assets being utilized.

### CROSS REFERENCE

This application claims the benefit of U.S. Provisional Application Ser. No. 63/188,276, filed May 13, 2021, which is hereby incorporated by reference in its entirety.

### TECHNICAL FIELD

Embodiments described herein generally relate to mission planning and, more specifically, to creating and editing a dynamic mission plan.

### BACKGROUND

Currently, multi-flight mission planning is often performed manually, requiring trial and error, as well as extensive operator time. Time and cost estimates on these current mission planning solutions can be off by 100% or more, resulting in large deployment inefficiencies. Coordination of these current solutions is currently performed over the radio with different vehicle operators, which can be difficult between independent entities. For example, in a search and rescue mission, a plurality of vehicles (or plurality of aerial vehicles) may be utilized to search an area, but with current solutions, multiple vehicles often search the same area, dramatically increasing time to mission completion, while significantly reducing probability of mission success. Consequently, a need exists in the industry for end-to-end multi-flight planning.

### SUMMARY

Systems and methods for flight mission planning are provided. One embodiment of a method includes defining a mission to be performed by a plurality of assets, where defining the mission includes defining an area for the mission and a target for the mission, determining, available assets for completing the mission, and determining a capability of the available assets. Some embodiments include defining operations to complete the mission, based on the capability of the available assets and assigning each of the operations to respective assets of the available assets to complete the mission, where assigning each of the operations incudes communicating customized instructions to each of the respective assets being utilized.

In another embodiment, a system includes a computing device that includes a processor and a memory component. The memory component stores logic that, when executed by the processor, causes the system to define a mission to be performed by a plurality of vehicles, where defining the mission includes defining an area for the mission and a target for the mission, determine available vehicles for completing the mission, and determine a capability for the available vehicles. In some embodiments, the logic causes the system to define operations to complete the mission, based on the capability of the available vehicles and assign each of the operations to respective vehicles of the available vehicles to complete the mission, where assigning each of the operations incudes communicating customized instructions to each of the respective vehicles being utilized.

In yet another embodiment, a computing device includes a processor and a memory component. The memory component stores logic that, when executed by the processor, causes the computing device to define a mission to be performed by a plurality of aerial vehicles, where defining the mission includes defining an area for the mission and a target for the mission, determine available aerial vehicles for completing the mission, and determine a capability for the available aerial vehicles. In some embodiments, the logic causes the computing device to define operations to complete the mission, based on the capability of the available aerial vehicles and assign each of the operations to respective aerial vehicles of the available aerial vehicles to complete the mission, where assigning each of the operations incudes communicating customized instructions to each of the respective aerial vehicles being utilized.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for mission planning, according to embodiments described herein;

FIG. 2 depicts an interface map for mission planning, according to embodiments described herein;

FIG. 3 depicts an area subdivided for a mission, according to embodiments described herein;

FIG. 4 depicts a planned path for a vehicle in a flight mission, according to embodiments described herein;

FIG. 5 depicts a flowchart for mission planning, according to embodiments described herein; and

FIG. 6 depicts a computing device for mission planning, according to embodiments described herein.

### DETAILED DESCRIPTION

Embodiments disclosed herein include systems and methods for mission planning. Some embodiments receive one or more mission objectives from a mission commander; determine a collection of operations (such as a first operation and a second operation) for the mission; and subdivide the mission into separate flights or operations. Depending on the embodiment, the mission may be accomplished by a plurality of nonhomogeneous assets (such as aerial vehicles). Embodiments may be configured to coordinate operations and flight planning, factoring realistic flight constraints for problems that may be dynamic in nature such as varying number of assets, while accounting for real-time updates such as changing airspace constraints. Some embodiments utilize a baseline solver combining Monte Carlo and local optimization techniques. Some embodiments solve distinct applications of coordinating operators in an area coverage problem, and conduct inspection missions of infrastructure spread over a wide area. The systems and methods for mission planning incorporating the same will be described in more detail, below.

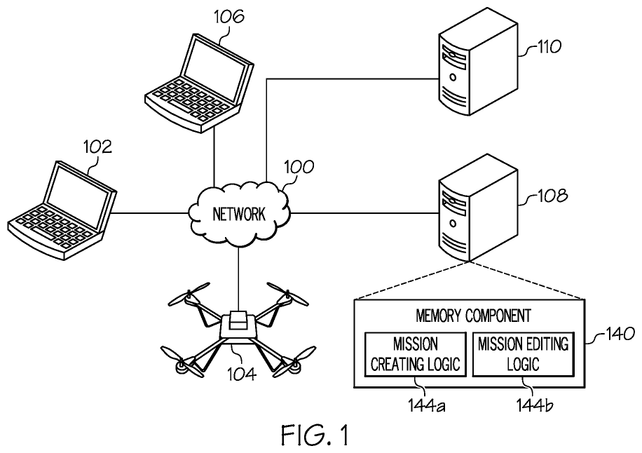

Referring now to the drawings, FIG. 1 depicts a computing environment for mission planning, according to embodiments described herein. As illustrated, the computing environment may include a network 100, such as the internet, public switched telephone network, mobile telephone network, mobile data network, local network (wired or wireless), peer-to-peer connection, and/or other network for providing the functionality described herein.

Coupled to the network 100 are a mission commander computing device 102, a vehicle 104, an operator computing device 106, a remote computing device 108, and a third party computing device 110. The mission commander computing device 102 may be configured as any device capable of communicating with the vehicle 104, the remote computing device 108, and/or the third party computing device 110. In some embodiments, the mission commander computing device 102 may be portable to provide at least some line of sight control over the vehicle 104. For some embodiments, the mission commander computing device 102 represents one or more devices for controlling the vehicle 104 and communicating with the other devices, as described herein. As such, the mission commander computing device 102 may be configured as a desktop computer, a laptop, a tablet, a mobile device, and/or other computing device for receiving input from and provide output to a mission commander or other user related to a mission.

The operator computing device 106 may be coupled to the network 100 and may also be configured as a desktop computer, laptop, mobile device and/or other computing device for receiving mission data and/or operations for the vehicle 104 to perform. The operator computing device 106 may also provide updated data regarding the status of the vehicle 104 and/or the status of the mission from the perspective of the operator, the operator computing device 106, and/or the vehicle 104.

The vehicle 104 may be configured as any asset to a mission, such as an aerial vehicle (including an unmanned aerial system (UAS), a small UAS (sUAS), unmanned aerial vehicle (UA), an airplane, helicopter, drone, etc.), a terrestrial vehicle, an aquatic vehicle, a satellite, a camera, a sensor, and/or any other component that may be deployed by the mission commander computing device 102 and/or the remote computing device 108 for completing the mission. The vehicle 104 may also include a local computing device for communicating with the mission commander computing device 102, the operator computing device 106, and/or the remote computing device 108. Similarly, the vehicle 104 may include one or more sensors for gathering data about the mission. As an example, the vehicle 104 may include a camera, LIDAR, radar, infrared sensors, audio sensors, and/or other sensors that may be used to complete the mission.

The remote computing device 108 may be configured as a desktop computer, a laptop, a tablet, a mobile device, a server, and/or other device for creating and/or editing a mission and providing other functionality provided herein. To this end, the remote computing device 108 may store mission creating logic 144a and mission editing logic 144b. The mission creating logic 144a may be configured to cause the remote computing device 108 to receive data regarding a mission provided by the mission commander computing device 102 (such as mission objectives, available assets, mission area, etc.), the operator computing device 106 (such as vehicle availability, vehicle capabilities, etc.), and/or the third party computing device 110 (such as weather data, airspace data, etc.). The mission creating logic 144a may additionally cause the remote computing device 108 to create operations for at least one of the assets that are available to complete the mission. The mission editing logic 144b may be configured to receive updates related to the mission (such as vehicle malfunction, mission updates, etc.); revise the mission based on the updates received; and communicate the updates to one or more of the devices depicted in FIG. 1.

Also coupled to the network 100 is the third party computing device 110. The third party computing device 110 may represent one or more computing devices that is operated by one or more third parties. The third party computing device 110 may be configured as a ground control system, detect and avoid systems, surveillance services providers, weather system, and/or other system with whom the other devices of FIG. 1 communicate regarding flight, operation, and/or navigation of the vehicle 104 and/or planning, editing, or monitoring of the mission. As will be understood, the third party computing device 110 may include hardware and/or software, similar to that described in reference to the remote computing device 108. In some embodiments, the third party computing device 110 may represent a plurality of different entities and/or computing devices for providing the functionality described herein. While labeled as third party computing device 110, it will be understood that this representation may be operated by any third party (or a plurality of individual third parties) to provide the requested data, as described herein.

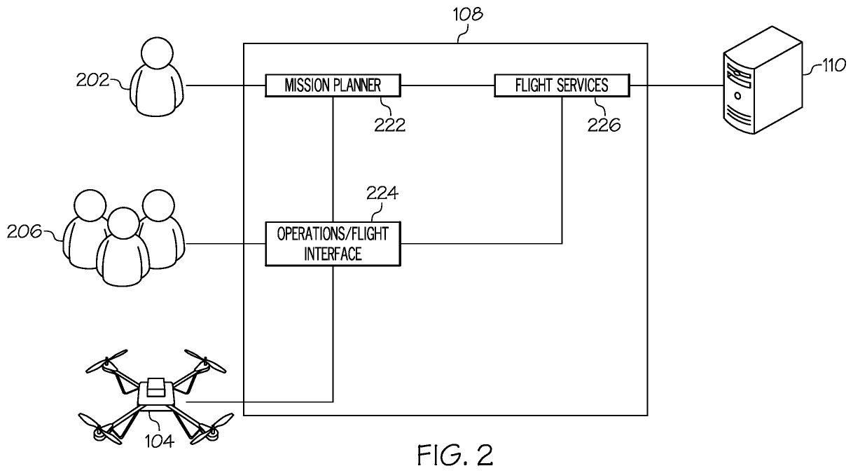

FIG. 2 depicts an interface map for mission planning, according to embodiments described herein. In some embodiments, the modules and/or interfaces may be provided by the remote computing device 108 via the mission creating logic 144a and/or the mission editing logic 144b. Regardless, a mission commander 202, operating the mission commander computing device 102 (FIG. 1), specifies one or more mission objectives (such as an area and a target), one or more task list, and/or one or more performance metrics through a user interface and/or file upload to the mission planner module 222. An operations interface 224 may be provided to communicate with the mission commander 202 and vehicle 104. The remote computing device 108 may maintain vehicle parameters, performance models, airspace constraints, performance metrics, and/or other data. The mission planner module 222 subdivides the mission into separate operations and assigns those operations to operators 206 and/or vehicles 104 that can handle those operations, based on availability, capability, cost, and/or other factors. These embodiments assist in coordination between operators 206 and flight planning for each operation in the operations interface 224. The mission planner module 222 provides to the operators 206 (via the operator computing device 106 from FIG. 1) the flight plan with a desired performance metric. In some embodiments, a flight services module 226 interacts with other flight service providers, such as UAS service providers (USSs) via the third party computing device 110 to maintain separation, satisfy operating rules and national airspace constraints, and monitor data feeds enabling participants to monitor the progress of the mission or respective operation. The airspace may be dynamic in nature and can affect the feasibility of the planned operation, requiring real time modification. These embodiments may also make additional recommendations, such as recommending how many assets should be deployed to solve a problem at operator deployment locations.

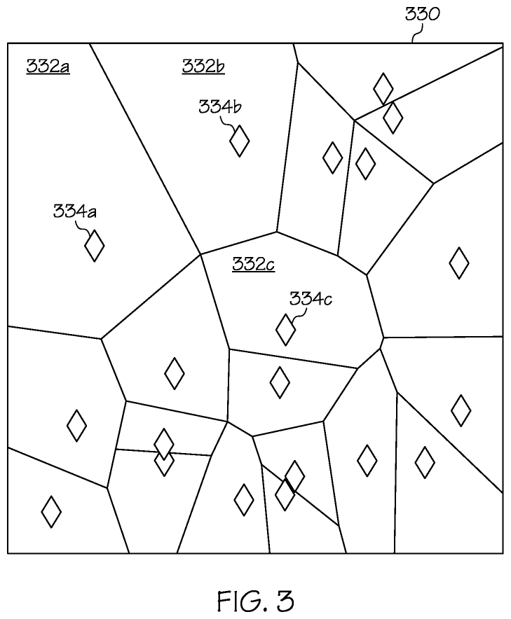

FIG. 3 depicts an area subdivided for a mission, according to embodiments described herein. As discussed above, when a mission commander 202 creates a mission, the mission commander 202 may define an area for the mission to occur and a target for the mission. The target may include one or more features or objectives of the mission. As an example, the mission may be defined as a search and rescue for a particular person with predetermined characteristics; as a utility inspection of particular infrastructure; as a population count; as a crop assessment, etc. With this information, the remote computing device 108 may segment the area into sub-areas 332a, 332b, 332c, etc., which may be assigned to respective assets (as part of the respective vehicles' operation). The mission commander 202 may additionally identify points of interest 334a, 334b, 334c, etc., to identify points or areas for which focus should be applied. The remote computing device 108 may receive information related to available vehicles 104, as well as capabilities for those vehicles 104 and third party data, such as weather, airspace, etc. With at least a portion of the received information, the remote computing device 108 may assign operations to one or more of the vehicles 104.

It should be understood that in some embodiments, points of interest 334a, 334b, 334c, etc. are selected first, and the sub-areas 332a, 332b, 332c, etc. are were created such that each point in the partition (such as a Voronoi partition) is associated with the closest points of interest 334a, 334b, 334c, etc. As such, some embodiments may subdivide the area and clusters objectives that can be solved together.

For a search and rescue mission, the operation may include a flight path, operation of a camera and/or other sensor to look for predetermined identifiers of the target. The vehicle 104 may capture imagery related to the flight path and that imagery may be analyzed for the predetermined identifiers. As an example, if the target was last seen using a red tent, an identifier may include a large surface with approximate dimensions of a red color. Another example would be utilizing a thermal imaging sensor to detect the target. Regardless, the mission commander computing device 102, vehicle 104, the operator computing device 106, the remote computing device 108, and/or other device may analyze the imagery and/or data captured by the vehicle 104 to assess a probability of locating the target or the predetermined identifiers.

As previously mentioned, the operation that each vehicle 104 is assigned may depend on capabilities of that vehicle 104. As an example, if a first vehicle 104 has a smaller range, that vehicle 104 may be assigned an operation that is closer to the operator computing device 106, a smaller area to cover and/or a smaller amount of airtime. The remote computing device 108 may also identify likely refueling times and other considerations when assigning operations. Other factors may also be considered when assigning operations, such as location of the operator 206. As an example, if one operator 206 is located 300 miles from the identified area, the remote computing device 108 may identify a time that the operator 206 could launch the vehicle 104, the cost for travel, lodging, etc., what area that vehicle 104 would most easily access, etc.

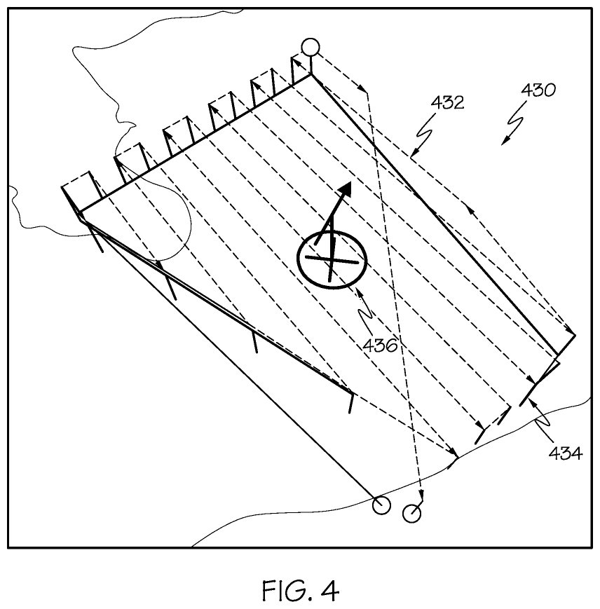

FIG. 4 depicts a planned path for a vehicle 104 in a mission, according to embodiments described herein. As illustrated, the remote computing device 108 may create an operation for a vehicle 104 as part of an overall mission. The operation may include a specific four dimensional path 430 (with a lateral instruction 432, an altitude instruction 434, a timing instruction, etc.) that the vehicle 104 will travel, as well as an orientation instruction 436, and a sensor activation instruction, such as camera, LIDAR, radar, infrared sensors, etc. Embodiments may additionally be configured to provide contingent instructions, such as if a plurality of heat signatures are found, determine a vector associated with a path of travel of a creator of the heat signatures and alter the current path to follow the vector. In some embodiments, the vehicle 104 may make this determination. In some embodiments, the remote computing device 108 may receive the data, create the vector, and instruct one or more vehicles 104 to pursue that operation.

As discussed above, the remote computing device 108 may create the mission and operations for the mission. However, embodiments described herein may continually, periodically, or otherwise reassess the status of the mission and modify the mission as the mission progresses to create an edited mission. Specifically, upon reassessment, a change to a characteristic of the mission may be detected. The change may include removal of at least one of the available asset (including an available vehicle or an available aerial vehicle), introduction of a new available asset (including a new available vehicle or new available aerial vehicle), change in weather, change in the area, alteration in operation of at least one of the available aerial vehicles, location of the identifier of the mission, location of the target of the mission, completion of the mission, and/or other change. Based on that change in characteristic, the remote computing device 108 may alter one or more of the operations to optimize the mission, based on the new information.

As an example, for a search and rescue mission, if an identifier is located or if other information is received indicating that the search area may be reduced (or expanded), the remote computing device 108 may adjust one or more of the operations accordingly. Similarly, if a vehicle 104 malfunctions, performs more efficiently than expected, or if a vehicle 104 is unexpectedly added or removed from the mission, the remote computing device 108 may alter the mission to more efficiently utilize the resources available at that time. Similarly, environmental conditions may unexpectedly change the predicted operation of the vehicles 104. If a rainstorm causes visibility to be reduced, the remote computing device 108 may determine that vehicles 104 utilizing cameras may be less effective and thus may be reassigned. The vehicles 104 utilizing radar, LIDAR, SONAR, or other sensors that are not affected by such visibility constraints may be reassigned different operations to more efficiently complete the mission. If changed characteristic is that the mission is completed, the vehicles 104 may be notified as such.

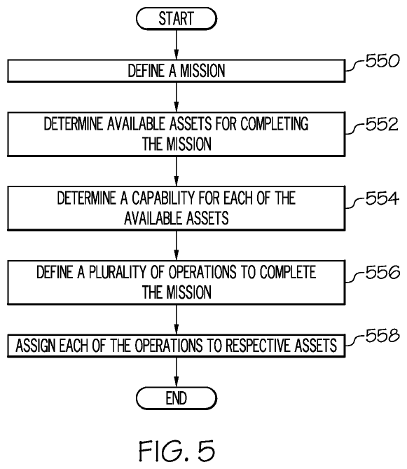

FIG. 5 depicts a flowchart for flight mission planning, according to embodiments described herein. As illustrated in block 550, a mission may be defined for performance by a plurality of assets. Defining the mission may include defining an area for the mission and a target for the mission. As an example, the mission may include locating a person in a forest with a defined perimeter. In block 552, available assets (such as available vehicles, available aerial vehicles, etc.) for completing the mission may be determined. This may include the remote computing device 108 communicating a signal to vehicles 104 and/or operators that are located in the vicinity for a request to assist in the mission. In some embodiments, the remote computing device 108 may already have connection with a fleet of one or more vehicles 104 that have been specifically deployed for this mission.

In block 554, a capability for the available assets may be determined. The remote computing device 108 may have access to a database of capabilities for a plurality of vehicles 104. When a vehicle 104 is engaged in a mission, the remote computing device 108 may access the database with a vehicle identifier to determine the capabilities of those vehicles 104 in the mission. In some embodiments, the vehicles 104 may individually communicate capabilities to the remote computing device 108 before beginning an operation. In some embodiments, a vehicle type may be determined by the remote computing device 108 (e.g., as communicated by the vehicle 104 to the remote computing device 108, as determined from a model number and/or a visual inspection of the vehicle 104, etc.). From the vehicle type, the remote computing device 108 may determine capabilities of the vehicle 104 and store for later access.

In block 556, a determination may be made regarding a plurality of operations to complete the mission, based on the capability of the available assets. The operations may be determined based on the topography of the search area, the line of sight availability, capabilities of one or more vehicles 104 being utilized for the mission, etc. In some embodiments, the operations may include segmenting a search area and/or assigning paths for a vehicle to traverse and/or sensors to activate. In some embodiments, the mission may include recharging stops, maintenance stops, reporting stops, etc.

In block 558, each of the operations may be assigned to respective assets of the available assets to complete the mission. Assigning the operations may include communicating a detailed 4-dimensional path to traverse, as well as sensors to operate. This data may be communicated from the remote computing device 108 to the operator computing device 106 and/or the vehicle 104 across the network 100. In some embodiments, the remote computing device 108 may provide an internet portal for operators to sign up for one or more missions. Such an embodiment may include the operator providing the information related to the asset and/or capabilities of the asset. If approved, the remote computing device 108 may then send the mission to the operator computing device 106 and/or vehicle 104.

As an example, the remote computing device 108 may select the vehicles 104 that will participate in the mission, based on the vehicle capabilities. The remote computing device 108 may additionally determine the operations for each of the vehicles 104, based on those capabilities. As an example, the remote computing device 108 may select 12 aerial vehicles. Of the 12 vehicles 104, two may have an extended battery life and two others may include an infrared sensor. The remote computing device 108 may thus send the two vehicles 104 with the extended battery to the farthest portions of the search area. The two vehicles 104 with infrared sensors may be sent to portions of the search area with low light conditions. Similarly, if the fleet of vehicles includes an aquatic vehicle, the remote computing device 108 may assign that vehicle 104 an operation that includes traversing waterways in the search area. As such, assigning each of the operations may include communicating customized instructions to each of the respective assets being utilized.

Additionally, some embodiments may be configured to provide the remote computing device 108 with updates on the status of the vehicles 104 during the mission. These updates may include status and/or diagnostic information on the vehicle, sensor data (e.g., images, sounds, etc.). With this information, the remote computing device 108 may manage one or more of the operations in real time or near real time. As an example, if the remote computing device 108 receives data (from the vehicle 104 and/or the operator computing device 106) indicating that the vehicle 104 has a faulty motor, the remote computing device 108 may decommission that vehicle 104 by communicating such an instruction to the vehicle 104 via the network 100 (FIG. 1), through the operator computing device 106, for example. Similarly, if the remote computing device 108 analyzes data from one or more vehicles 104 indicative of noise in a particular section of the search area, the remote computing device 108 may create one or more new operations and reassign one or more vehicles 104 to those new operations to hone the mission, based on this new information. Again, such a communication may include an electronic communication across the network 100 to the operator computing device 106 and/or the vehicle 104.

In some embodiments, the remote computing device 108 creates a probability model to improve the efficiency of completing the mission. As an example, if the mission is defined as locating a person in a predefined area, the remote computing device 108 may first receive input regarding clues that may assist in completing the mission. The clues may include a time and a location of when the person entered the predefined area, an average speed of someone in that terrain, etc. With the input data, a probability of completing the mission at a plurality of sub-areas 332 (FIG. 3) within the predetermined area may be determined, which may also be based on capabilities of the vehicles 104, as well as the operations of those vehicles. As the vehicles 104 acquire additional data, the probability model may be automatically updated.

As an example, if a first vehicle 104 detects a garment that the person was wearing, the probability of locating the person in that particular sub area 332a (FIG. 3) may increase and the probability of finding the person in other sub areas (e.g., 332b, 332c, etc.) may decrease. Because of this change in the probability model, the remote computing device 108 may reallocate the vehicles 104 and/or reconfigure one or more of the sub areas 332 to new and/or edited operations that concentrate the vehicles 104 in the higher probability region. As such, the remote computing device 108 makes these adjustments and communicates the new and/or edited operations to the vehicles 104 directly, via the operator computing device 106 and/or to other computing devices, such as those depicted in FIG. 1.

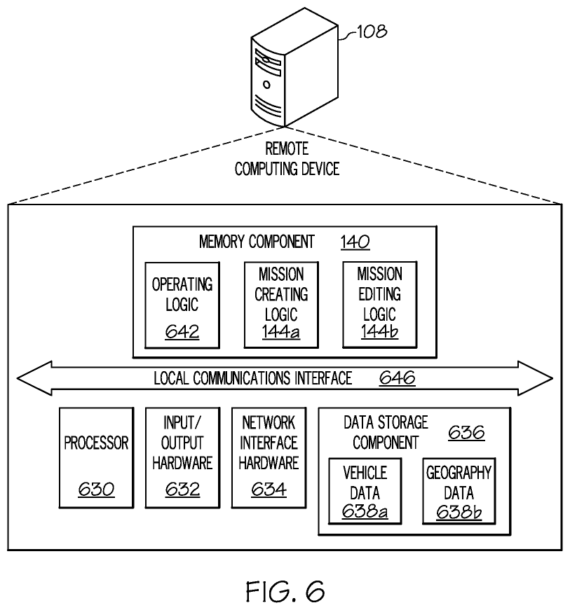

FIG. 6 depicts a remote computing device 108 for flight mission planning, according to embodiments described herein. As illustrated, the remote computing device 108 includes a processor 630, input/output hardware 632, network interface hardware 634, a data storage component 636, which stores vehicle data 638a, geography data 638b, and/or other data, and the memory component 140. The vehicle data 638a may include information regarding the vehicle 104 (or vehicles) being utilized or considered for utilization in the mission, the specifications of the vehicle 104, vehicle sensors, and/or other similar data. The geography data 638b may include information regarding the geography of the area that the mission will take place, including weather data, topography, terrain, points of interest 334, and/or other data.

The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 108 and/or external to the remote computing device 108.

The memory component 140 may store operating system logic 642, the mission creating logic 144a, and the mission editing logic 144b. As discussed above, the mission creating logic 144a and the mission editing logic 144b may each include a plurality of different pieces of logic (or combined into a single piece of logic), each of which may be embodied as a computer program or module, firmware, and/or hardware, as an example. A local interface 646 is also included in FIG. 6 and may be implemented as a bus or other communication interface to facilitate communication among the components of the remote computing device 108.

The processor 630 may include any processing component operable to receive and execute instructions (such as from a data storage component 636 and/or the memory component 140). As described above, the input/output hardware 632 may include and/or be configured to interface with the components of FIG. 6.

The network interface hardware 634 may include and/or be configured for communicating with any wired or wireless networking hardware, including an antenna, a modem, a LAN port, wireless fidelity (Wi-Fi) card, WiMAX card, mobile communications hardware, and/or other hardware for communicating with other networks and/or devices. From this connection, communication may be facilitated between the remote computing device 108 and other computing devices, such as those depicted in FIG. 1.

The operating system logic 642 may include an operating system and/or other software for managing components of the remote computing device 108. As discussed above, the mission creating logic 144a may reside in the memory component 140 and may be configured to cause the processor 630 and the remote computing device 108 to utilize the vehicle data 638a, the geography data 638b, and/or other data for creating a mission with available resources. The mission editing logic 144b may reside in the memory component 140 and may be configured to cause the processor 630 and the remote computing device 108 to receive changes in the mission (such as changes in available vehicles, changes in area, changes is data utilized for editing the mission, etc.); utilize that data to alter the mission operations for one or more of the vehicles; and/or perform other functions described herein.

It should be understood that while the components in FIG. 6 are illustrated as residing within the remote computing device 108, this is merely an example. In some embodiments, one or more of the components may reside external to the remote computing device 108. It should also be understood that, while the remote computing device 108 is illustrated as a single device, this is also merely an example. In some embodiments, the mission creating logic 144a and/or the mission editing logic 144b may reside on different computing devices. As another example, one or more of the functionalities and/or components described herein may be provided by the mission commander computing device 102, the vehicle 104, the operator computing device 106, the third party computing device 110, and/or other devices, which may be coupled to the remote computing device 108 via a network connection (wired or wireless). These devices may also include hardware and/or software for performing the functionality described herein.

Additionally, while the remote computing device 108 is illustrated with the mission creating logic 144a and the mission editing logic 144b as separate logical components, this is also an example. In some embodiments, a single piece of logic (or multiple pieces of logic) may cause the desired computing device to provide the described functionality.

As illustrated above, various embodiments flight mission planning are disclosed. These embodiments provide more efficient field operations: conduct more tasks in less time, increasing throughput. Additionally, these embodiments provide a common framework for a wide variety of missions, flexible mission planning with changes in mission scope or available assets, reduced operator workload. Superficially, no time is consumed to create a mission. Mission planning is supremely accurate, both in terms of creating operations, as well as time estimates and cost estimates. Accordingly, embodiments may be useful for utilities, transportation, oil and gas, wind farms, governments, aircraft contractors performing surveys, first responders, insurance adjusters, air mobility for package delivery, etc.

Additionally, these embodiments provide a system and/or method that is able to remotely and electronically communicate an operation with a vehicle 104 directly, via an operator computing device 106 and/or other computing device (such as depicted in FIG. 1), while the vehicle 104 is remote from the remote computing device 108. These embodiments may thus coordinate a plurality (e.g., dozens, hundreds, thousands, etc.) of vehicles 104 on different operations that is part of a common mission. As the vehicles 104 may come from remote locations, such functionality would be impossible but for the remote computing device 108 that can register each vehicle 104 remotely, determine capabilities of each of the vehicles 104, and assign the operation accordingly. Additionally, some embodiments of the remote computing device 108 may receive sensor data from one or more of the vehicles 104 during and/or after the operation; alter one or more operations of the mission, based on that information and revise operations and/or create new operations, based on that data.

Further aspects of the invention are provided by the subject matter of the following clauses:

A first aspect includes a method comprising: defining, by a computing device, a mission to be performed by a plurality of assets, wherein defining the mission includes defining an area for the mission and a target for the mission; determining, by the computing device, a plurality of available assets for completing the mission; determining, by the computing device, a capability for each of the plurality of available assets; defining, by the computing device, operations for the plurality of available assets to complete the mission, based on the capability of each the plurality of available assets; and assigning, by the computing device, each of the operations to respective assets of the plurality of available assets to complete the mission, wherein assigning each of the operations incudes communicating customized instructions to each of the respective assets being utilized.

A second aspect includes the method of the preceding aspect, wherein the plurality of assets includes at least one of the following: aerial vehicle, a terrestrial vehicle, an aquatic vehicle, a satellite, a camera, or a sensor.

A third aspect includes the method of any preceding aspect, further comprising: reassessing a status of the mission; determining a change to a characteristic of the mission; editing at least one of the operations to create an edited mission, based on the change; and communicating data related to the edited mission for implementation.

A fourth aspect includes the method of any preceding aspect, wherein the change includes at least one of the following: removal of at least one of the plurality of available assets, introduction of a new available asset, change in weather, change in the area, alteration in operation of at least one of the plurality of available assets, location of an identifier of the mission, location of the target of the mission, or completion of the mission.

A fifth aspect includes the method of any preceding aspect, wherein the change includes an asset completing a first operation that is assigned to the asset, and wherein the method further comprises assigning a second operation to the asset.

A sixth aspect includes the method of any preceding aspect, wherein the mission includes at least one of the following: search and rescue, a utility inspection, a population count, or a crop assessment.

A seventh aspect includes the method of any preceding aspect, wherein the customized instructions include at least one of the following: a lateral instruction, an altitude instruction, a timing instruction, an orientation instruction, or a sensor activation instruction.

An eighth aspect includes a system comprising: a computing device that includes a processor and a memory component, wherein the memory component stores logic that, when executed by the processor, causes the system to perform at least the following: define a mission to be performed by a plurality of vehicles, wherein defining the mission includes defining an area for the mission and a target for the mission; determine available vehicles for completing the mission; determine a capability for the available vehicles; define operations to complete the mission, based on the capability of the available vehicles; and assign each of the operations to respective vehicles of the available vehicles to complete the mission, wherein assigning each of the operations incudes communicating customized instructions to each of the respective vehicles being utilized.

A ninth aspect includes the system of the eighth aspect, further comprising a mission commander computing device that receives the area and the target for the mission via input from a mission commander.

A tenth aspect includes the system of the eighth aspect and/or ninth aspect, wherein the plurality of vehicles includes at least one of the following: aerial vehicle, a terrestrial vehicle, or an aquatic vehicle.

An eleventh aspect includes the system of any of the eighth aspect through tenth aspect, wherein the logic further causes the system to perform at least the following: receive data from at least one of the available vehicles; reassess a status of the mission, based on the data; determine a change to a characteristic of the mission, based on the status; edit at least one of the operations to create an edited mission, based on the change; and communicate data related to the edited mission to the at least one of the available vehicles for implementation.

A twelfth aspect includes the system of any of the ninth aspect through the eleventh aspect, wherein the change includes at least one of the following: removal of at least one of the available vehicles, introduction of a new available vehicle, change in weather, change in the area, alteration in operation of at least one of the available vehicles, location of an identifier of the mission, location of the target of the mission, or completion of the mission.

A thirteenth aspect includes the system of any of the ninth aspect through the twelfth aspect, wherein the change includes a vehicle completing a first operation that is assigned to the vehicle, and wherein the logic further causes the system to assign a second operation to the vehicle.

A fourteenth aspect includes the system of any of the ninth aspect through the thirteenth aspect, wherein the customized instructions include at least one of the following: a lateral instruction, an altitude instruction, a timing instruction, an orientation instruction, or a sensor activation instruction.

A fifteenth aspect includes the system of any of the ninth aspect through the fourteenth aspect, wherein the customized instructions include at least one of the following: a lateral instruction, an altitude instruction, a timing instruction, an orientation instruction, or a sensor activation instruction.

A sixteenth aspect includes a computing device comprising: a processor; and a memory component, wherein the memory component stores logic that, when executed by the processor, causes the computing device to perform at least the following: define a mission to be performed by a plurality of aerial vehicles, wherein defining the mission includes defining an area for the mission and a target for the mission; determine available aerial vehicles for completing the mission; determine a capability for the available aerial vehicles; define operations to complete the mission, based on the capability of the available aerial vehicles; and assign each of the operations to respective aerial vehicles of the available aerial vehicles to complete the mission, wherein assigning each of the operations incudes communicating customized instructions to each of the respective aerial vehicles being utilized.

A seventeenth aspect includes the computing device of the sixteenth aspect, wherein the logic further causes the computing device to perform at least the following: reassess a status of the mission; determine a change to a characteristic of the mission, based on the status; edit at least one of the operations to create an edited mission, based on the change; and communicate data related to the edited mission to at least one of the available aerial vehicles for implementation.

An eighteenth aspect includes the computing device of the sixteenth aspect and/or the seventeenth aspect, wherein the change includes at least one of the following: removal of at least one of the available aerial vehicles, introduction of a new available aerial vehicle, change in weather, change in the area, alteration in operation of at least one of the available aerial vehicles, location of an identifier of the mission, location of the target of the mission, or completion of the mission.

A nineteenth aspect includes the computing device of any of the sixteenth aspect through the eighteenth aspect, wherein the change includes an aerial vehicle completing a first operation that is assigned to the aerial vehicle, and wherein the logic further causes the computing device to assign a second operation to the aerial vehicle.

A twentieth aspect includes the computing device of any of the sixteenth aspect through the nineteenth aspect, wherein the mission includes at least one of the following: search and rescue, a utility inspection, a population count, or a crop assessment.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for mission planning. It should also be understood that these embodiments are merely exemplary and are not intended to limit the scope of this disclosure.

What is claimed is:

1. A method comprising:
defining, by a computing device, a mission to be performed by a plurality of assets, wherein defining the mission includes defining an area for the mission and a target for the mission;
determining, by the computing device, a plurality of available assets for completing the mission;
determining, by the computing device, a capability for each of the plurality of available assets;
defining, by the computing device, operations for the plurality of available assets to complete the mission, based on the capability of each the plurality of available assets; and
assigning, by the computing device, each of the operations to respective assets of the plurality of available assets to complete the mission, wherein assigning each of the operations incudes communicating customized instructions to each of the respective assets being utilized.

2. The method of claim 1, wherein the plurality of assets includes at least one of the following: aerial vehicle, a terrestrial vehicle, an aquatic vehicle, a satellite, a camera, or a sensor.

3. The method of claim 1, further comprising:
reassessing a status of the mission;
determining a change to a characteristic of the mission;
editing at least one of the operations to create an edited mission, based on the change; and
communicating data related to the edited mission for implementation.

4. The method of claim 3, wherein the change includes at least one of the following:
removal of at least one of the plurality of available assets, introduction of a new available asset, change in weather, change in the area, alteration in operation of at least one of the plurality of available assets, location of an identifier of the mission, location of the target of the mission, or completion of the mission.

5. The method of claim 3, wherein the change includes an asset completing a first operation that is assigned to the asset, and wherein the method further comprises assigning a second operation to the asset.

6. The method of claim 1, wherein the mission includes at least one of the following:
search and rescue, a utility inspection, a population count, or a crop assessment.

7. The method of claim 1, wherein the customized instructions include at least one of the following: a lateral instruction, an altitude instruction, a timing instruction, an orientation instruction, or a sensor activation instruction.

8. A system comprising:
a computing device that includes a processor and a memory component, wherein the memory component stores logic that, when executed by the processor, causes the system to perform at least the following:
define a mission to be performed by a plurality of vehicles, wherein defining the mission includes defining an area for the mission and a target for the mission;
determine available vehicles for completing the mission;
determine a capability for the available vehicles;
define operations to complete the mission, based on the capability of the available vehicles; and
assign each of the operations to respective vehicles of the available vehicles to complete the mission, wherein assigning each of the operations incudes communicating customized instructions to each of the respective vehicles being utilized.

9. The system of claim 8, further comprising a mission commander computing device that receives the area and the target for the mission via input from a mission commander.

10. The system of claim 8, wherein the plurality of vehicles includes at least one of the following: aerial vehicle, a terrestrial vehicle, or an aquatic vehicle.

11. The system of claim 8, wherein the logic further causes the system to perform at least the following:
receive data from at least one of the available vehicles;
reassess a status of the mission, based on the data;
determine a change to a characteristic of the mission, based on the status;
edit at least one of the operations to create an edited mission, based on the change; and
communicate data related to the edited mission to the at least one of the available vehicles for implementation.

12. The system of claim 11, wherein the change includes at least one of the following: removal of at least one of the available vehicles, introduction of a new available vehicle, change in weather, change in the area, alteration in operation of at least one of the available vehicles, location of an identifier of the mission, location of the target of the mission, or completion of the mission.

13. The system of claim 11, wherein the change includes a vehicle completing a first operation that is assigned to the vehicle, and wherein the logic further causes the system to assign a second operation to the vehicle.

14. The system of claim 8, wherein the mission includes at least one of the following: search and rescue, a utility inspection, a population count, or a crop assessment.

15. The system of claim 8, wherein the customized instructions include at least one of the following: a lateral instruction, an altitude instruction, a timing instruction, an orientation instruction, or a sensor activation instruction.

16. A computing device comprising:
a processor; and
a memory component, wherein the memory component stores logic that, when executed by the processor, causes the computing device to perform at least the following:
define a mission to be performed by a plurality of aerial vehicles, wherein defining the mission includes defining an area for the mission and a target for the mission;
determine available aerial vehicles for completing the mission;
determine a capability for the available aerial vehicles;
define operations to complete the mission, based on the capability of the available aerial vehicles; and
assign each of the operations to respective aerial vehicles of the available aerial vehicles to complete the mission, wherein assigning each of the operations incudes communicating customized instructions to each of the respective aerial vehicles being utilized.

17. The computing device of claim 16, wherein the logic further causes the computing device to perform at least the following:
reassess a status of the mission;
determine a change to a characteristic of the mission, based on the status;
edit at least one of the operations to create an edited mission, based on the change; and
communicate data related to the edited mission to at least one of the available aerial vehicles for implementation.

18. The computing device of claim 17, wherein the change includes at least one of the following: removal of at least one of the available aerial vehicles, introduction of a new available aerial vehicle, change in weather, change in the area, alteration in operation of at least one of the available aerial vehicles, location of an identifier of the mission, location of the target of the mission, or completion of the mission.

19. The computing device of claim 17, wherein the change includes an aerial vehicle completing a first operation that is assigned to the aerial vehicle, and wherein the logic further causes the computing device to assign a second operation to the aerial vehicle.

20. The computing device of claim 16, wherein the mission includes at least one of the following: search and rescue, a utility inspection, a population count, or a crop assessment.
